(19) United States
(12) Patent Application Publication
(10) Pub. No.: US 2008/0243831 A1
(43) Pub. Date: Oct. 2, 2008

(54) INFORMATION PROCESSING APPARATUS, INFORMATION PROCESSING SYSTEM, AND STORAGE MEDIUM

(75) Inventor: Setsu Kunitake, Kanagawa (JP)

Correspondence Address: GAUTHIER & CONNORS, LLP, 225 FRANKLIN STREET, SUITE 2300, BOSTON, MA, 02110, US

(73) Assignee: FUJI XEROX CO., LTD., Tokyo (JP)

(21) Appl. No.: 11/942,943

(22) Filed: Nov. 20, 2007

(30) Foreign Application Priority Data
Apr. 2, 2007 (JP) 2007096111

(51) Int. Cl. G06F 17/30

(52) U.S. Cl. 707/5; 707/E17.014; 707/E17.017

(57) ABSTRACT

A first information processing apparatus includes a registration unit that receives, from an information processing apparatus, information of a derivation relationship in which a first document is a parent and a second document generated as a result of an operation performed with respect to the first document is a child and registers the information in a storage unit, and a search result output unit that, in accordance with a search instruction that specifies a designated document and a search condition including a condition that defines a derivation relationship that should exist between the designated document and a search subject document, outputs, as a search result, information concerning a document that satisfies the search condition among documents included in derivation relationships registered in the storage unit.

### CROSS-REFERENCE TO RELATED APPLICATIONS

This application is based on and claims priority under 35 USC 119 from Japanese Patent Application No. 2007-096111, filed on Apr. 2, 2007.

### BACKGROUND

1. Technical Field

The present invention relates to an information processing apparatus, an information processing system, and a storage medium.

2. Related Art

Technologies have been developed for notifying a user of updating of an electronic document in a system in which electronic documents are registered in a server.

### SUMMARY

According to one aspect of invention, there is provided a first information processing apparatus including a registration unit that receives, from an information processing apparatus, information of a derivation relationship in which a first document is a parent and a second document generated as a result of an operation performed with respect to the first document is a child and registers the information in a storage unit; and a search result output unit that, in accordance with a search instruction that specifies a designated document and a search condition including a condition that defines a derivation relationship that should exist between the designated document and a search subject document, outputs, as a search result, information concerning a document that satisfies the search condition among documents included in derivation relationships registered in the storage unit.

### BRIEF DESCRIPTION OF THE DRAWINGS

Exemplary embodiments of the present invention will be described in detail based on the following figures, wherein:

FIG. 1 is a block diagram schematically showing an example structure of a document use management system;

FIG. 2 is a block diagram showing an example internal structure of a client terminal;

FIG. 3 is a view schematically showing an example data structure of an ID-added document;

FIG. 4 is a block diagram showing an example internal structure of a document management server;

FIG. 5 is a view showing example data content registered in a derivation relationship DB;

FIG. 6 is a view schematically showing a tree structure formed by a group of management IDs in the data content shown in FIG. 5;

FIG. 7 is a view showing an example display screen for receiving setting of a notification condition;

FIG. 8 is a flowchart showing an example processing procedure of a request processing unit;

FIG. 9 is a flowchart showing, in detail, a part of the example processing procedure of the request processing unit;

FIG. 10 is a view showing an example display screen that displays a window for indicating a search result provided from a document management server;

FIG. 11 is a view showing example data content registered in a derivation relationship DB in an example modification;

FIG. 12 is a view schematically showing a tree structure formed by a group of management IDs in the data content shown in FIG. 11;

FIG. 13 is a flowchart showing an example processing procedure of the request processing unit;

FIG. 14 is a flowchart showing, in detail, a part of the example processing procedure of the request processing unit;

FIG. 15 is a view showing example data content registered in a derivation relationship DB in an example modification;

FIG. 16 is a view schematically showing a tree structure formed by a group of management IDs in the data content shown in FIG. 15;

FIG. 17 is a flowchart showing an example processing procedure of the request processing unit;

FIG. 18 is a flowchart showing, in detail, a part of the example processing procedure of the request processing unit; and

FIG. 19 is a view showing an example hardware structure of a computer.

### DETAILED DESCRIPTION

Exemplary embodiments of the present invention will be described in detail with reference to the accompanying drawings.

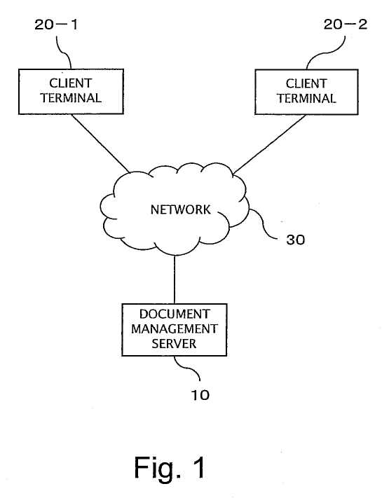

FIG. 1 is a block diagram schematically showing a structure of a document use management system. This system is formed of a document management server 10 and client terminals 20-1, 20-2, . . . (hereinafter collectively referred to as a client terminal 20) that are connected to each other via a network 30 such as the Internet, a Local Area Network, or the like.

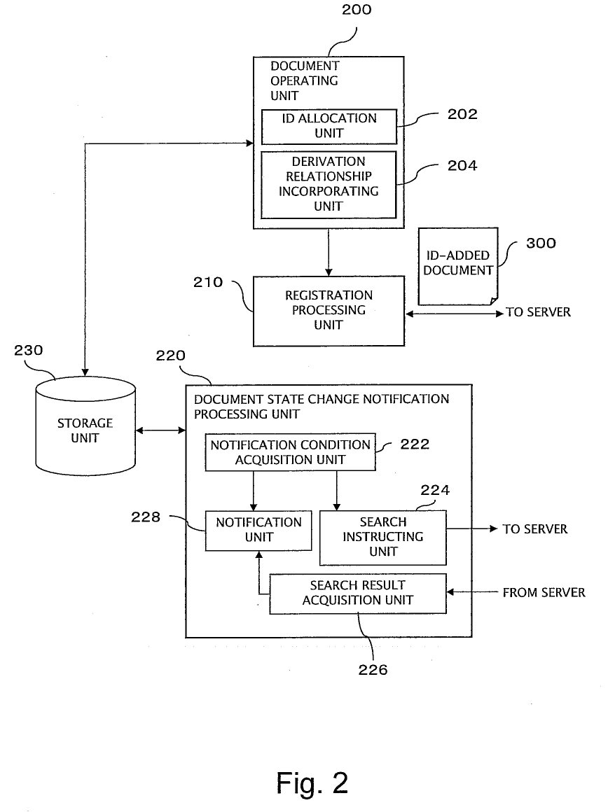

The client terminal 20 will be described with reference to FIG. 2. The client terminal 20 is a terminal used by a user for performing an operation with respect to a document, and may be a personal computer, a digital multifunction device (an image-forming device having a copier function, a facsimile function, and a printer function), or the like. As shown in FIG. 2, the client terminal 20 includes a document operating unit 200, a registration processing unit 210, a document state change notification processing unit 220, and a storage unit 230.

The document operating unit 200 is used for performing an operation with respect to a document, including display (i.e. “viewing” by a user), editing, printing and output of a document, reading and copying of a paper document, and the like. Although only a single document operating unit 200 is shown in FIG. 2, the individual operations may be performed by different operating units (e.g. different applications such as an editing application and a reading control application). If the document operating unit 200 is software used for creating and editing an electronic document, such as a word processing program, for example, the document operating unit 200, in accordance with a user's instruction, displays an electronic document or edits the electronic document. The document operating unit 200, when performing an operation with respect to a document, outputs an ID-added document 300 that represents a result of the operation.

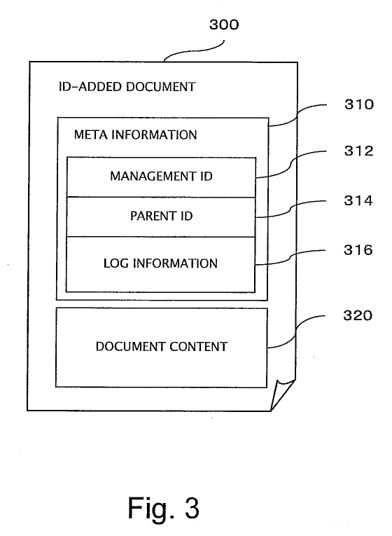

As shown in FIG. 3, the ID-added document 300 is an electronic document including meta information 310 and document content 320. The document content 320 corresponds to content data of a document that is generated as a result of the operation performed by the document operating unit 200. If the document operating unit 200 is software that creates and edits an electronic document, the document content 320 is a document file generated as a result of editing performed by the software. Alternatively, if the document operating unit 200 is a device that prints an electronic document, the document content 320 may be content data of an electronic document to be printed. Further, if the document operating unit 200 is a device that scans a paper document or a device that copies a paper document, the document content 320 may be image data acquired by reading the paper document.

The meta information 310 is information used for document management, and includes a management ID 312, a parent ID 314, and log information 316.

The management ID 312 is unique identification information of an ID-added document 300 itself. The parent ID 314 is a management ID of a parent ID-added document of that ID-added document 300. Specifically, in this exemplary embodiment, a certain ID-added document and a new ID-added document acquired by performing an operation with respect to the certain ID-added document are treated as being in a parent-child relationship. More specifically, when a second ID-added document is acquired by performing an operation with respect to a first ID-added document, the first ID-added document is a parent of the second ID-added document, and the second ID-added document is a child of the first ID-added document. For example, when the document operating unit 200 performs an operation with respect to an ID-added document having a management ID “A” and a new ID-added document having a management ID “B” is acquired as a result of the operation, the management ID 312 in the meta information 310 of the latter document is “B” and the parent ID 314 of this document is “A.” Such a parent-child relationship will be referred to as a “derivation relationship (of management IDs).”

Here, in a case wherein an operation of initially registering an electronic document which has not been registered in the present system is performed and also in a case wherein an operation of scanning or copying an unregistered paper document is performed (in the latter case, an ID-added document including an image acquired by reading the paper document as its document content is generated and registered in the present system), the ID-added document 300 which is generated would have no parent ID 314 (that is, no parent exits).

The log information 316 refers to information of various log items concerning the operation performed when the ID-added document is generated. The log items may include the time and date when the operation is performed, the type of the operation, a user (operator) who instructed the operation, and the like, and are not limited to these examples. The operation types include, for example, registration (i.e. registration of a new document in the present system), viewing, editing, updating (registration of an updated version), printing, scanning, copy of a paper document, and the like. For example, when a user uses the document operating unit 200 to edit a first ID-added document and then instructs completion of editing, the log information 316 of the resulting second ID-added document includes the time and date of editing completion, identification information of a user who instructed the editing, and the type of operation “editing.”

Here, the operation types included in the log information 316 are operation types corresponding to the classification intended for recording logs and need not correspond to the operation types actually executed by the document operating unit 200. In this regard, multiple operation types executed by the document operating unit 200 may be associated with a single operation type intended for log recording. For example, in both the case where an ID-added electronic document is edited on a document editing application and “registration as an updated version” is instructed on an operation menu and the case where a paper document with a management ID is read and “registration of a read document as an approved version” is instructed on the operation menu of the reading control application, the same value of the operation type “updating” is to be included in the log information 316.

A specific example of the meta information 310 generated by the document operating unit 200 is as follows.

### EXAMPLE 1

<metadata sid=“Doc2” date=“2006-01-10T10:20:00” method=“register” user=“user1” pid=“null”/>

Here, the sid attribute corresponds to a management ID, the date attribute corresponds to operation time and date, and the method attribute corresponds to an operation type. Further, the user attribute corresponds to user identification information of a user who instructed the operation, and the pid attribute corresponds to a parent ID. The method attribute value “register” in Example 1 represents a name of an operation type indicative of a registration operation of a new document (which has not been registered in the document management server 10). Because the target operation is registration of a new document, “null” indicative of no parent is set as the value of the pid attribute indicative of a parent ID. Here, when no parent ID exists, the pid attribute may be omitted rather than explicit inclusion of the attribute indicating that no parent ID exists.

The log information 316 may also include a “disclosure” attribute indicative of whether or not the ID-added document 300 is a subject of disclosure (or a subject of sharing). Assuming that a “disclosure” attribute value of an ID-added document that is a subject of disclosure is “1” and a “disclosure” attribute value of an ID-added document that is not a subject of disclosure is “0,” the ID-added document having the “disclosure” attribute value “0” would not be disclosed to those other than privileged users including an operator who performed an operation for generating that document, a manager, and so on.

Here, the value of the “disclosure” attribute is determined in accordance with the type of operation. Either the types of operations executed by the document operating unit 200 or the types of operations in accordance with classification intended for log recording may be used as criteria for determining the disclosure attribute values. Which type of operations is to be adopted is simply set in the document operating unit 200.

A specific example of the meta information 310 generated by the document operating unit 200 when the “disclosure” attribute is included in the log information 316 is as follows.

### EXAMPLE 2

<metadata sid=“Doc5” date=“2006-10-11T23:45:00” method=“update” user=“user1” pid=“Doc2” shared=“1”/>

Example 2 is meta information 310 generated when a user corresponding to user identification information “user1” performs an operation of editing with respect to a document having a management ID “Doc2” to “register (the resulting document) as an updated version.” Here, the method attribute value “update” represents an updating operation. In this example, the document that is registered as a result of an updating operation is a subject of disclosure, and therefore the shared attribute value is “1” indicative of a disclosure subject.

Referring back to FIG. 2, the document operating unit 200 includes an ID allocation unit 202 and a derivation relationship incorporating unit 204 so as to generate the ID-added document 300 described above as a result of an operation. The ID allocation unit 202 assigns a unique management ID to an ID-added document generated as a result of an operation. The management ID needs to be identification information that is unique at least within the present system. For example, it is possible to acquire a hash value of an ID-added document 300 (excluding the management ID 312) to be generated as a result of an operation and use the hash value as a management ID of the ID-added document 300. When a collision-resistant cryptographic hash function, such as SHA-256 (that is, a cryptographic hash function having a hash value of 256 bits defined in FIPS (Federal Information Processing Standards) 180-2 by the NIST (National Institute of Standards and Technology)), is used as the hash function, a management ID having practically sufficient uniqueness can be generated. As a matter of course, a method of generating a management ID that is unique within the system by each client terminal 20 is not limited to the above example. When the management ID includes identification information that is specific to each client terminal 20, the management ID that is unique within the system can be generated in each client terminal 20.

The derivation relationship incorporating unit 204 generates meta information 310 including a new management ID 312 assigned to a document acquired by a result of an operation by the ID allocation unit 202, a parent ID 314 that is a management ID of a parent document with respect to which the operation has been performed (in the case of initial registration, no such parent ID exists), and log information 316 concerning the operation. Here, the derivation relationship incorporating unit 204 holds information concerning a correspondence relationship indicating a correspondence between the individual operation types executed by the document operating unit 200 and the individual operation types intended for log recording, and, using such information, acquires a value of the operation type to be included in the log information. The derivation relationship incorporating unit 204 also holds information, for each operation type, as to whether or not a document acquired as a result of the operation should be designated as a subject of disclosure, and by reference to such information determines a value of the shared attribute. The derivation relationship incorporating unit 204 then adds the meta information 310 to the document content of the operation result to thereby generate and output an ID-added document 300 acquired after the operation.

When the document operating unit 200 is application software, the ID allocation unit 202 and the derivation relationship incorporating unit 204 may be implemented as a plug-in program which is added to the software.

The registration processing unit 210 performs processing for registering the ID-added document 300 output from the document operating unit 200 to the document management server 10. Thus, each client terminal 20 registers to the document management server 10 as described above the ID-added document 300 acquired as a result of an operation performed by each client terminal 20 itself, so that the document management server 10 can recognize the derivation relationship between each ID-added document 300.

The document state change notification processing unit 220 issues to the document management server 10 a search instruction in which a designated document and a search condition are specified. A designated document is a document that is designated by a user, and information concerning a document related to this designated document is searched and retrieved through the document management server 10. When a user wishes to acquire information concerning a document related to a certain document, the user sets such a certain document as a designated document. A search condition is a condition that defines concerning what document information is to be searched. The document management server 10, upon receiving a search instruction that specifies a designated document and a search condition from the document state change notification processing unit 220, provides the client terminal 20 a search result including information concerning a document that is related to the designated document and that satisfies the search condition. The document state change notification processing unit 220, upon receiving the search result from the document management server 10, performs processing for notifying a user of the search result that is received. The document state change notification processing unit 220 includes a notification condition acquisition unit 222, a search instructing unit 224, a search result acquisition unit 226, and a notification unit 228.

The notification condition acquisition unit 222 acquires a notification condition that is used in a processing operation performed by the document state change notification processing unit 220. The notification condition includes a condition that determines a designated document and a search condition. The condition that determines a designated document is set such that, in a file system on the storage unit 230 of the client terminal 20 or a storage unit of another client terminal or a server terminal connected to the client terminal 20, for example, a document stored in a certain folder is determined as a designated document. Alternatively, the condition that determines a designated document may be a condition that a document of a certain type is determined as a designated document, or a condition that a document having a specific management ID is determined as a designated document. The search condition includes a condition of a derivation relationship that defines a derivation relationship that should exist between the designated document and a search subject document. The condition of a derivation relationship will be described in detail below. Further, the search condition may include a condition related to an operation performed with respect to a document. Here, the condition related to an operation is a condition that specifies an operation type, the time of an operation, an operator, and the like.

Further, the notification condition may include designation of a notification time which is a timing at which the document state change notification processing unit 220 performs a notification processing operation. By designating the notification time, setting is achieved such that notification is performed at a fixed interval (for example, 60 minutes or 180 minutes) or at a certain time, for example. For example, setting may be achieved such that a notification processing is performed during a time period when a user does not use the client terminal 20, such as during the nighttime. Also, the notification time may be set by reference to the usage situation of the client terminal 20, irrespective of the time and time intervals. For example, the notification time may be set such that a notification processing is performed when a user executes log-on processing for starting the use of the client terminal 20.

Further, the notification condition may include designation of a notification method. The notification method refers to a method for notifying a user of the search result acquired from the document management server 10 by the document state change notification processing unit 220. The notification method includes, for example, displaying a search result in a display region on a display screen of the client terminal 20 (window display), changing a display mode of an icon representing a designated document on the display screen of the client terminal 20, transmitting an electronic mail including a search result, and the like. By designating the notification method, a user is notified of a search result provided by the document management server 10 in a manner desired by the user.

The notification condition acquisition unit 222 acquires the notification condition by reading a setting file in which the notification condition is described. An example description content of a setting file for the notification condition is as follows.

### EXAMPLE 3

C:¥check∓readuser, descendent and method=read, 180, window

In Example 3, the character string “C:¥check¥readuser” before the first comma “,” represents a condition that an ID-added document stored in a folder indicated by “C:¥check¥readuser” in a file system within the storage unit 230 of the client terminal 20 is specified as a designated document, which is a condition that determines a designated document. The character string “descendent and method=read” between the first and second commas “,” represents a search condition. In this search condition, the portion “descendent” represents a condition of a derivation relationship that a document corresponding to a descendent of a designated document in the tree structure indicating a derivation relationship among documents is designated as a search subject. Further, the portion “method=read” in the search condition represents a condition for setting such that a document with regard to which an operation type is “viewing” is to be searched. As such, the search condition “descendent and method=read” refers to a condition that specifies “a document corresponding to a descendent of a designated document” and “a document with regard to which an operation type is ‘viewing.’” The numerals “180” between the second and third commas “,” represents a condition of a notification time that specifies that notification is performed at intervals of 180 minutes. The character string “window” following the third comma “,” represents a condition of a notification method that specifies that window display of a search result.

The search instructing unit 224 issues a search instruction to the document management server 10 in accordance with the notification condition received from the notification condition acquisition unit 222.

The search result acquisition unit 226 receives a search result provided from the document management server 10 and provides the search result to the notification unit 228.

The notification unit 228 performs processing for notifying a user of the search result received from the search result acquisition unit 226, in accordance with a notification method designated by the notification condition received from the notification condition acquisition unit 222.

The storage unit 230 stores a document with respect to which an operation has been performed by the document operating unit 200, and so on.

The ID-added document 300 output from the document operating unit 200 as a result of an operation can be sent to others by electronically copying or by attaching the same to an electronic mail and the like, similar to cases with general document files. Here, because, in this example, software for use in transmission of an electronic mail does not comply with the present system, this transmission operation is not reflected in an ID-added document and therefore is not recorded in the document management server 10. When a user who receives an ID-added document 300 from another user uses the document operating unit 200 of his/her own client terminal 20 to perform an operation with respect to the received ID-added document 300, a new ID-added document to which a new management ID is assigned in accordance with the operation is to be generated.

Further, when printing an electronic document, the document operating unit 200 may generate a management ID and embed the management ID in the printed electronic document. Here, embedding of the management ID can be performed, for example, by superposing a code image representing the management ID with a printed image of the electronic document. Further, when a print sheet includes an RFID (Radio Frequency Identifier) tag, the management ID may be written in the RFID tag. When such a printing operation is performed, the document operating unit 200 registers an ID-added document including meta information such as the management ID, the operation type, which is “printing” in this case, and the like, in the document management server 10. Here, when an ID-added document is printed, a new ID-added document including the management ID of the ID-added document as a parent ID 314 is generated. The new ID-added document corresponding to such a printing operation may include, as the document content 320, printing data such as page description language data and bit map image data representing a printed image or a document file which is to be printed.

Further, when a paper document having a management ID embedded therein is read by the document operating unit 200, the document operating unit 200 assigns a new management ID with respect to the reading operation, and generates an ID-added document including an image of the reading result as the document content 320 and registers the ID-added document in the document management server 10. The management ID read from the original paper document is set as a parent ID 314 of the ID-added document. At the time of copying a paper document having a management ID embedded therein, both the reading processing and the printing processing described above are to be performed.

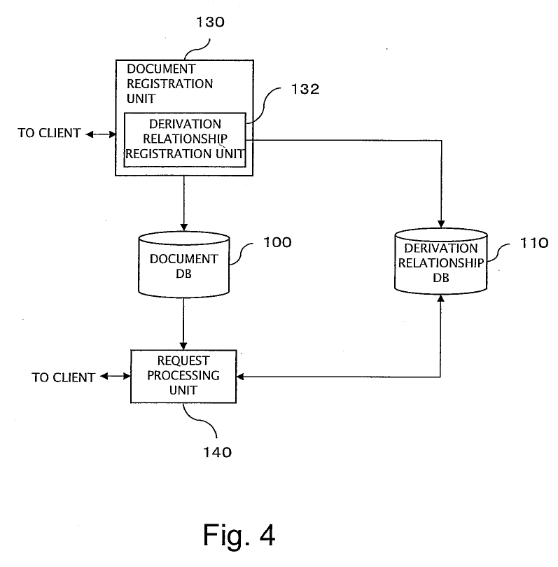

Next, the document management server 10 will be described. The document management server 10 stores ID-added documents 300 sent from multiple client terminals 20 in the system and provides various services to users in accordance with the stored information. As shown in FIG. 4, the document management server 10 includes a document DB 100, a derivation relationship DB 110, a document registration unit 130, and a request processing unit 140.

The document DB 100 is a database that stores document content 320 of an ID-added document 300 transmitted from the client terminal 20. Each set of document content 320 stored in the document DB 100 may be managed by reference to a unique content ID. Although a hash value obtained by a cyptographic hash function of the corresponding document content may be used as the content ID, the content ID is not limited to this example. The content ID may be assigned by the client terminal 20, in which case the content ID may be included in the meta information 310. Alternatively, in place of assigning the content ID, the document content 320 may be stored in the document DB 100 in association with a management ID of the ID-added document 300 corresponding to that document content.

The document registration unit 130 registers the document content and the meta information of an ID-added document received from the client terminal 20 in the document DB 100 and the derivation relationship DB 110, respectively. Of these registration operations, registration of the meta information is performed by the derivation relationship registration unit 132.

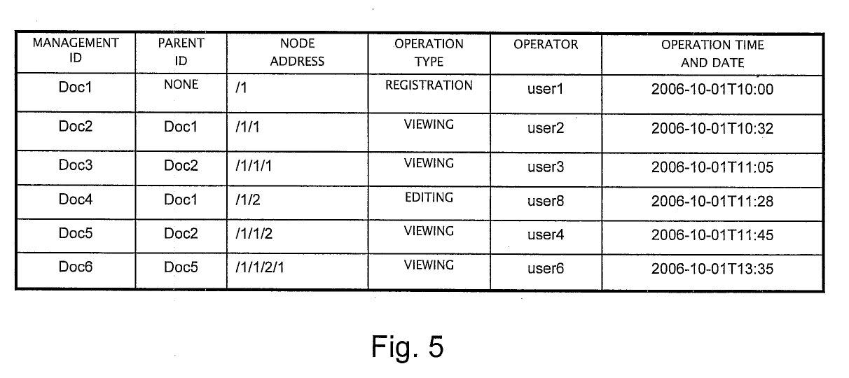

The derivation relationship DB 110 is a database that stores meta information mainly concerning the information of a derivation relationship in such an ID-added document 300. FIG. 5 shows example data content of the derivation relationship DB 110. The information in one row in the table shown in FIG. 5 represents a meta information record corresponding to one ID-added document 300. In this example, items including a parent ID, a node address, an operation type, an operator, and an operation time and date, are registered in correspondence to the management ID of each ID-added document 300. The information items in the meta information record are not limited to the above example, and any items necessary for the purpose of management can be recorded, so long as the pair consisting of the management ID and the parent ID is included. Here, the operation type, the operator, and the operation time and date have been described above. A node address indicates a position of a node corresponding to the noted management ID (noted ID-added document) in a tree formed by derivation relationships among ID-added documents. In the description of a node address, the symbol “/” indicates a separator between hierarchical depths of the tree and a numeral indicates the order among children derived from the same parent. For example, a node “/1” indicates a root node corresponding to a document that is registered by an operation of a new document registration. Further, a node “/1/1” indicates a first child of the root node “/1,” and a node “/1/2” indicates the second child of the root node “/1.” Although, for the sake of simplicity, FIG. 5 shows only a group of meta information records belonging to a single tree that is derived from a single root node “/1,” the document management server 10 can actually register groups of meta information records belonging to multiple trees, such as a tree derived from a root “/1” and a tree derived from a root “/2.” Further, in the example shown in FIG. 5, an item of the “disclosure” attribute described above is not included. When all the registered documents can be a subject of disclosure such as in a case where a limitation is imposed on the users of the present system, for example, setting of the “disclosure” attribute can be omitted so that all the documents can be treated as a subject of disclosure.

Here, FIG. 5 merely expresses the data managed by the derivation relationship DB 110 from a viewpoint of data content, and does not therefore specify any specific expression form or database form. For example, the derivation relationship DB 110 may be configured as a general relational database, or a database in which a XML (eXtensible Markup Language) document that describes meta information other than the management ID is registered with the management ID being used as a key.

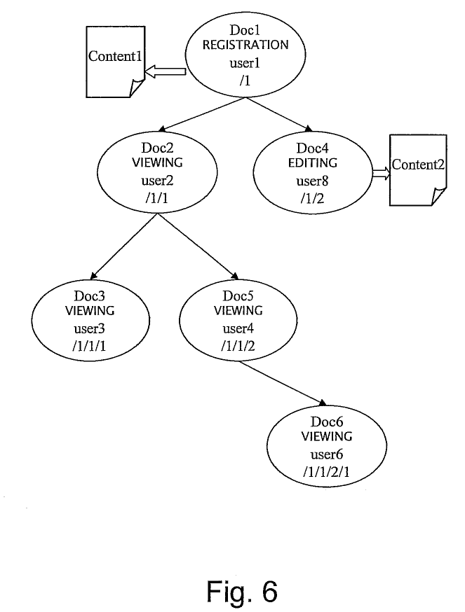

The data content of the derivation relationship DB 110 shown in FIG. 5 forms a tree structure as shown in FIG. 6, with a management ID being represented as a node and a parent-child relationship being represented as an edge.

The log of the documents shown in FIGS. 5 and 6 will be described below in time sequence. First, a “registration” operation of a document which has not been registered in the document management server 10 is performed by a client terminal of user1. Here, the “registration” operation refers to an operation for registering in the document management server 10 a document which has not been registered in the document management server 10 (i.e. a document having no management ID). In accordance with this operation, an ID-added document “Doc1” including meta information having a management ID “Doc1,” no parent ID, and an operation type “registration,” and the document content of that document is sent from the client terminal of user1 to the document management server 10. In response, the document management server 10 registers the document content and the meta information in the ID-added document “Doc1” in the document DB 100 and the derivation relationship DB 110, respectively. Here, the document management server 10, recognizing that the operation type is “registration” and the parent ID is vacant, determines that this ID-added document is a root (initiator) of a new tree, rather than a child of any ID-added document that has been already registered in the document management server 10, and sets a value of a node address (“/1” in this example) accordingly. Hereinafter, for the purpose of identification, the document content which is registered is represented by the content ID “Content1.” Thereafter, user1 distributes the ID-added document thus registered to other users, such as user2, user3, and so on. Such distribution is achieved by sending an electronic mail having the ID-added document attached thereto to each user.

Thereafter, another user user2 views the ID-added document “Doc1” by using the document operating unit 200 of his/her own client terminal. Here, what is actually viewed by user2 is the document content having a content ID “Content1.” As a result of viewing, the client terminal generates an ID-added document “Doc2,” which is then registered in the document management server 10. The meta information of this ID-added document includes a management ID “Doc2,” a parent ID “Doc1,” an operator “user2,” and an operation type “viewing.” Further, because the document content is not changed by the “viewing” operation, the document content retains “Content1.” When the document content is not changed by an operation as described above, the client terminal 20 may send an ID-added document with no document content to the document management server 10. Recognizing, from the value of the parent ID of the received ID-added document, that the document “Doc2” is a child, particularly a first child, of the document “Doc1,” the document management server 10 sets the node address of the document “Doc2” to “/1/1.”

With this operation, the ID-added document “Doc1” that has been present in the client terminal 20 of user2 before this operation is replaced with the ID-added document “Doc2” by means of the derivation relationship incorporating unit 204. Specifically, the derivation relationship incorporating unit 204 changes the management ID 312 in the meta information 310 of the earlier ID-added document “Doc1” to the ID “Doc2” that was newly issued, and also sets the management ID “Doc1” of the earlier document “Doc1” as a value of the parent ID 314. Further, the derivation relationship incorporating unit 204 changes a value of the operation type in the log information 316 to “viewing,” which is the type of operation performed this time, changes a value of the operation time to the time and date of viewing, and changes a value of the operator to user2. Here, because the content of a document remains unchanged by the “viewing” operation, the value of the document content 320 retains “Content1.”

As described above, the ID-added document “Doc1,” once being viewed, is replaced with the ID-added document “Doc2” after viewing. Accordingly, after such replacement, the ID-added document “Doc1” itself does not exist in the client terminal 20 and instead the ID-added document “Doc2” exists in the client terminal 20.

Then, another user3 receives the ID-added document “Doc2” after having been viewed by user2, by means of an electronic mail or the like, and views the ID-added document “Doc2” by using the document operating unit 200 of the client terminal. An ID-added document “Doc3” acquired as a result of viewing is then registered in the document management server 10. Here, what is viewed by user3 is the document content having a content ID “Content1.” With this operation, the ID-added document “Doc2” that has been present in the client terminal 20 of user3 before this operation is replaced with the ID-added document “Doc3” by means of the derivation relationship incorporating unit 204. Specifically, the derivation relationship incorporating unit 204 changes the management ID 312 in the meta information 310 of the earlier ID-added document “Doc2” to the ID “Doc3” that was newly issued, and also sets the management ID “Doc2” of the earlier document “Doc2” as a value of the parent ID 314. Further, the derivation relationship incorporating unit 204 changes a value of the operation time to the time and date of viewing and changes a value of the operator to user3. The value of the operation type in the log information 316 remains “viewing.” Here, because the operation performed this time is again “viewing” as in the previous operation, the value of the document content 320 remains unchanged.

Next, the ID-added document “Doc1” distributed from user1 is edited by the document operating unit 200 of the client terminal of user8. The client terminal then generates a new ID-added document “Doc4” including the document content “Content2” which is a result of the editing, a parent ID “Doc1,” and a value of the operation type “editing,” and registers the document in the document management server 10. The ID-added document “Doc1” in the client terminal of user8 is replaced with this ID-added document “Doc4.”

Then, user4 views the ID-added document “Doc2” by using the document operating unit 200 of the client terminal, and a resultant ID-added document “Doc5” is registered in the document management server 10. The ID-added document “Doc2” in the client terminal of user4 is then replaced with this ID-added document “Doc5.” Then, this the ID-added document “Doc5” is further viewed by user6 by means of the document operating unit 200 of the client terminal, and a resultant ID-added document “Doc6” is registered in the document management server 10. The ID-added document “Doc5” in the client terminal of user6 is then replaced with this ID-added document “Doc6.”

FIGS. 5 and 6 show the documents derived from “Doc1” and the corresponding operations within the derivation relationship DB 110 at this point in time.

Heretofore, how the information of document operations is registered in the present system has been described while the data content of the derivation relationship DB 110 has been used as an example.

Referring again to FIG. 4, the request processing unit 140 provides a service by using the derivation relationship DB 110, in response to a service request including the management ID transmitted from the client terminal 20. A service to be provided by the request processing unit 140 may include search of the latest version of a document corresponding to the management ID for which the service is being requested. Another example service may be a service of providing an initiator (root) document corresponding to the management ID for which the service is being requested or the log information of the initiator, or a service of providing the history of the management ID; that is, an operation history of the documents from the initiator up to the management ID (i.e. an information list indicating who performed what kind of operation, and so on). A further example service may be a service of receiving a specified search condition concerning the attribute items registered in the derivation relationship DB 110 and providing a list of ID-added documents that satisfy the search condition. Here, the service of searching for the latest version described above may be regarded as a service of providing a search result concerning a search condition that “the operation date and time is the latest.” Also, the service of providing information of the initiator document described above may be regarded as a service of providing a search result concerning a condition that specifies “a document with a node address corresponding to a root.”

The service request is issued by reference to an ID-added document held by the client terminal 20. For example, when a user operates the document operating unit 200 of the client terminal 20 to open an ID-added document, the document operating unit 200 provides a service menu, services in the menu using the derivation relationship, receives the user's designation of a desired service among services in the menu, and transmits to the request processing unit 140 of the document management server 10 a service request including the document ID of the ID-added document and a code indicating the designated service. At this time, a search condition that is input through a user interface screen provided for designating a search condition concerning the attribute items including the user identification information, the operation time and date, and so on, may be transmitted to the request processing unit 140 in combination with the service request. Also, in addition to the management ID, the code indicating a designated service, and the search condition described above, other information including identification information of a user who issued the instruction, authentication information input by a user, and the like, may also be transmitted from the client terminal 20 to the request processing unit 140.

Alternatively, it is also conceivable to regard a user's designation of a service as one “operation” and assign a new management ID to the “operation.” In this case, it is possible to generate an ID-added document including a code of the designated service as an operation type and the management ID of the original ID-added document that was used at the time of designation of a service as a parent ID, and transmit this ID-added document to the document management server 10 as a service request. In this case, the request processing unit 140 determines a service to be provided by reference to the information of an operation type in the ID-added document that is received and uses the parent ID of that ID-added document as a start point when tracing back the derivation relationship.

Upon receiving a service request from the client terminal 20, the request processing unit 140 traverses, starting from the management ID for which a service is being requested, a tree configured by the derivation relationships between the management IDs and the parent IDs registered in the derivation relationship DB 110. The request processing unit 140 then uses the information acquired as a result of traverse to perform the service requested by the user.

A processing for notifying a user of a change in the document state in the system according to the exemplary embodiment will be described.

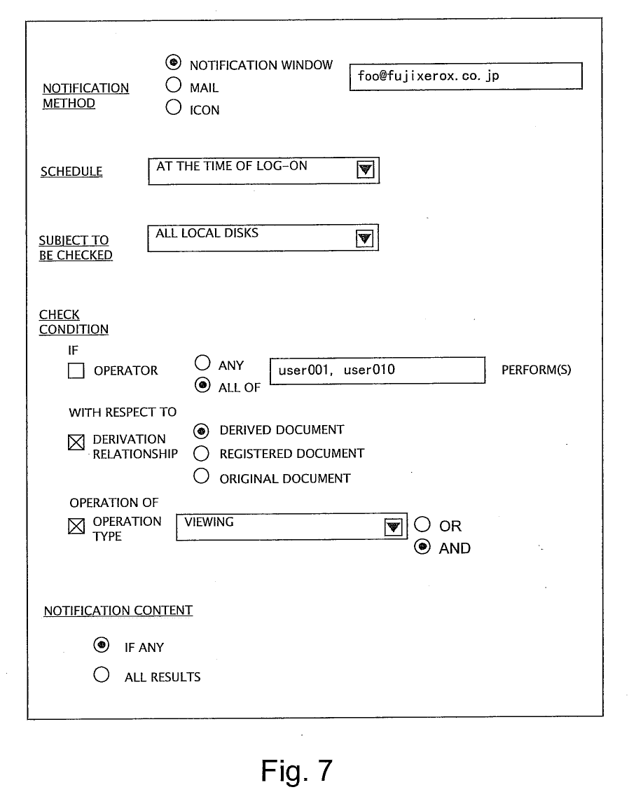

The notification condition acquisition unit 222 of the client terminal 20 performs processing for acquiring a notification condition. For example, the notification condition acquisition unit 222 causes a display apparatus to display a screen shown in FIG. 7 for receiving user input. The user then sets a notification condition in accordance with the screen display.

On the screen display shown in FIG. 7, with regard to the item “notification method,” the user designates a notification method among the methods described above. In the example shown in FIG. 7, “notification window,” “mail,” and “icon” are provided as options of the notification method. If the “notification window” is designated, the notification unit 228 displays a window indicating a search result on the display screen of the client terminal 20. If the “mail” is designated, the notification unit 228 performs processing for sending an electronic mail including a search result to a designated e-mail address. If the “icon” is designated, the notification unit 228 performs a processing for changing the display mode of an icon representing a designated document on the display screen of the client terminal 20.

With regard to the item “schedule,” the user sets the notification time described above. In the example shown in FIG. 7 in which “at the time of log-on” is set, the notification processing is performed when a user executes log-on processing in order to start using the client terminal 20.

With regard to the item “subject to be checked,” the user sets a condition that specifies a designated document. In the example shown in FIG. 7 in which “all local disks” is set, all the ID-added documents stored in the storage unit 230 of the client terminal 20 could be considered a designated document.

With regard to the item of “check condition,” the user sets a search condition described above. FIG. 7 shows an example intended for a case where three items, “operator,” “derivation relationship,” and “operation type,” are set. With regard to the item “operator,” a user who performed a processing for generating an ID-added document is designated. With regard to the item “operation type,” a type of the operation by which the ID-added document is generated is specified. With regard to the item “derivation relationship,” a condition of the derivation relationship that should exist between the designated document and a search subject document is designated. This condition of derivation relationship defines what positional relationship of the nodes is given between the designated document and a document to be searched in a tree structure represented by the records within the derivation relationship DB 110 of the document management server 10. For example, if a “derived document” is selected in the example shown in FIG. 7, a condition that specifies “a document corresponding to a descendent of a designated document” is set as the condition of derivation relationship, and if a “registered document” is selected, a condition that specifies “a document belonging to the tree to which a designated document belongs” is set. In the example shown in FIG. 7, the content of a condition of derivation relationship that is set when an “original document” is selected will be described below. The conditions of derivation relationship are not limited to those illustrated in FIG. 7, and there may be adopted any condition which specifies a relationship between nodes in the tree structure, such as a “document included in the route between a designated document and a document corresponding to an initiator of the designated document.”

Conditions concerning the items other than those indicated in the example of FIG. 7 may also be set as a search condition. For example, there may be set a condition concerning the operation time, such as “a document with regard to which the operation time is the latest,” “a document with regard to which the operation time is the earliest,” “a document with regard to which the operation time is the closest to that of the designated document,” “a document with regard to which the operation time is later than the operation time of the designated document,” and the like.

The user may combine each item of the search condition with a logical formula and designate such a search condition. In the example shown in FIG. 7, with regard to the items “operator,” “derivation relationship,” and “operation type,” the items selected by a user are incorporated in a search condition with an AND condition. If multiple users are designated for “operator,” a condition of the operator would be whether one (OR condition) or all (AND condition) of the multiple users have performed an operation. Similarly, if multiple operation types are designated for “operation type,” a condition formed by combining multiple operation types with an OR or AND condition is set as a condition of operation type.

The item of “notification content” designates content of information to be provided when performing notification of a search result. In the example shown in FIG. 7, the user is supposed to select “if any” or “total number.” When “if any” is designated, in a case where even one document satisfying the check condition exists, information concerning that document is to be provided. When “total number” is designated, a total number of documents satisfying the check condition is to be provided. Here, in addition to the total number of documents satisfying the check condition, the information concerning the documents may also be included in the information content when “total number” is designated, although receipt of such a condition setting is not indicated in FIG. 7.

The notification condition acquisition unit 222 receives the notification condition set by a user and provides the notification condition that is received to the search instructing unit 224 and the notification unit 228.

The search instructing unit 224 provides a search instruction to the document management server 10 at the notification time designated by the notification condition received from the notification condition acquisition unit 222. In this search instruction processing, the search instructing unit 224 first acquires a management ID of a designated document in accordance with the condition for specifying a designated document included in the notification condition. For example, the search instructing unit 244 acquires a management ID of an ID-added document included in the designated folder in the storage unit 230. Then, the search instructing unit 224 transmits to the document management server 10 the management ID of the designated document and the information that defines the search condition.

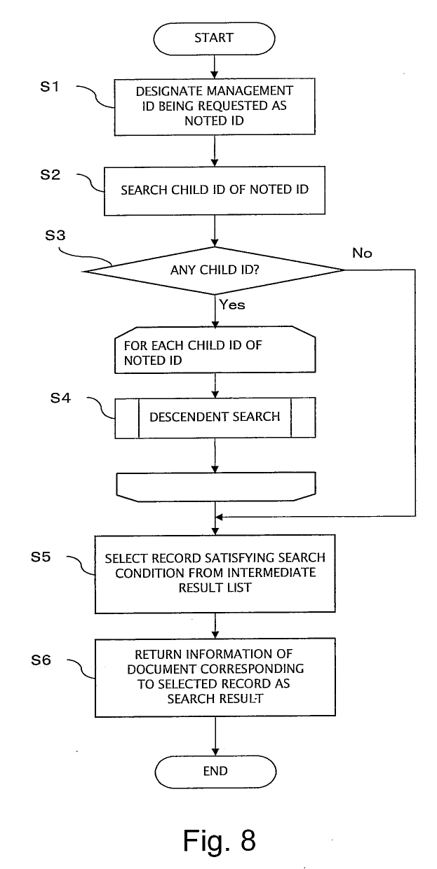

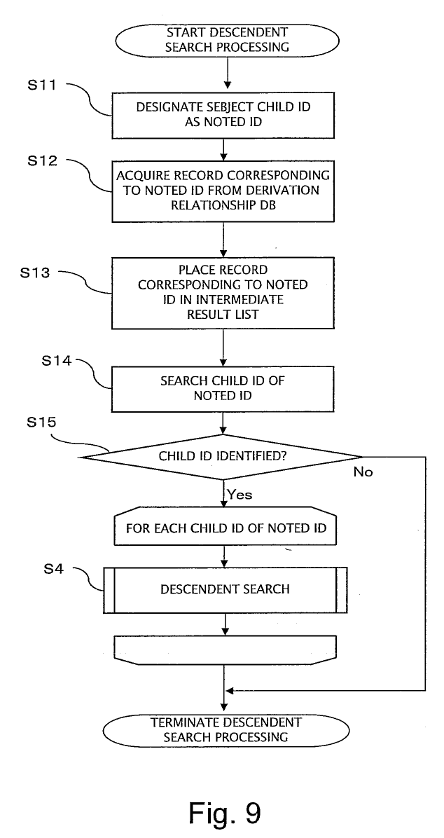

Hereinafter, the processing procedure performed by the request processing unit 140 of the document management server 10 when receiving a search instruction (a service request) from the search instructing unit 224 of the client terminal 20 will be described. First, in accordance with the condition of a derivation relationship included in the search condition specified by the search instruction, the request processing unit 140 performs search processing in which a document having a derivation relationship defined by this condition of a derivation relationship with respect to a designated document is designated as a search subject. For example, if the search condition includes a condition of a derivation relationship that specifies “a document corresponding to a descendent of a designated document,” the request processing unit 140 performs a processing procedure illustrated in FIGS. 8 and 9. Hereinafter, with reference to FIGS. 8 and 9, there will be described a specific example in which a search instruction is issued from the client terminal 20 of user2, with the ID-added document “Doc2” being designated as a designated document and with a search condition including a condition of a derivation relationship that specifies “a document corresponding to a descendent of the designated document” and a condition that specifies “a document with regard of which an operation type is ‘viewing.’” Further, in this specific example, it is assumed that data content of the derivation relationship DB 110 is as shown in FIGS. 5 and 6.

Referring to FIG. 8, in step S1, the request processing unit 140 first extracts a management ID of the designated document from the service request (the search instruction) received from the client terminal 20 and sets the extracted management ID as a noted ID. Then, in step S2, the request processing unit 140 searches the derivation relationship DB 110 for a child ID of the noted ID. Here, the “management ID” of a record having the noted ID as a value of the “parent ID” in the derivation relationship DB 110 is the child ID of the noted ID. Further, in step S3, a determination is made as to whether or not a child ID of the noted ID has been identified. If there are any child IDs, the request processing unit 140 performs descendent search processing as shown in FIG. 9 with regard to each of the child IDs. If the result of determination shows that no child IDs of the noted ID are present, the process proceeds to step S5 without performing processing in step S4.

Once the descendent search processing in step S4 starts, the request processing unit 140 sets the subject child ID as a noted ID in step S11 of FIG. 9. Then, in step S12, the request processing unit 140 acquires a record corresponding to the noted ID from the derivation relationship DB 110. In step S13, the request processing unit 140 places the record acquired in step S12 in an intermediate result list. Here, the intermediate result list is a list that is assembled so as to accumulate information as materials for acquiring the results of the requested processing.

The request processing unit 140 searches for a child ID of the noted ID in step S14, and determines whether or not any child IDs can be identified in step S15. If there are any child IDs, the request processing unit 140 recursively performs the descendent search processing in step S4 for each child ID. When the descendent search processing is completed for all the child IDs, the processing concerning the noted ID is completed. Also, if it is determined in step S15 that no child IDs are present, the processing concerning the noted ID is terminated.

Referring back to FIG. 8, when the descendent search processing in step S4 is completed for all the child IDs of the noted ID, the records corresponding to the documents derived from a document corresponding to the noted ID are supposed to be accumulated in the intermediate result list. If the noted ID is “Doc2” in FIG. 5, the management IDs “Doc3,” “Doc5,” and “Doc6” are stored in the intermediate result list. The request processing unit 140, in step S5, selects a record that satisfies the search condition from the records registered in the intermediate result list. In a case where a condition that “the operation type is ‘viewing’ ” is set as the search condition, when records having the management IDs “Doc3,” “Doc5,” and “Doc6” (all of which include the operation type “viewing”) are stored in the intermediate result list, all the records within the intermediate result list are to be selected. In step S6, the request processing unit 140 provides, as a search result, information concerning the documents corresponding to the records selected in step S5. Here, the request processing unit 140 may provide the contents of the corresponding documents or may provide the contents of a specific item of the record of the corresponding documents. Alternatively, the request processing unit 140 may send all the contents of the records selected in step S5 to the client terminal 20. Further, if there are no records that satisfy the search condition in the intermediate result list in step S5, the request processing unit 140, in step S6, sends to the client terminal 20 information indicative of the fact that no documents that satisfy the search condition could be identified.

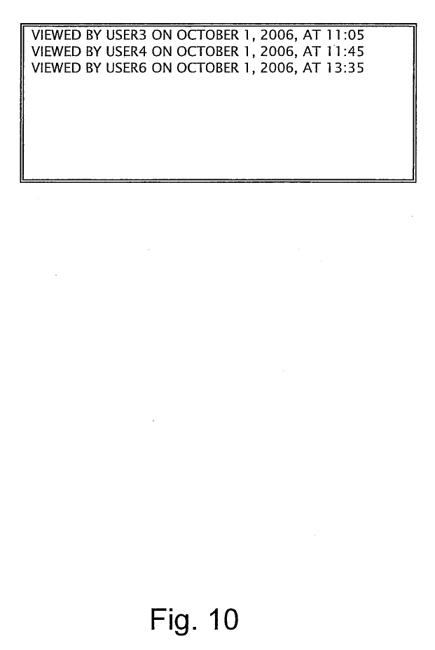

The search result acquisition unit 226 of the client terminal 20 receives the search result provided from the document management server 10 and then transfers the received search result to the notification unit 228. The notification unit 228 performs a processing for notifying the user of the search result in accordance with the method specified in the notification condition. It is assumed, for example, that the content of the record selected in step 5 of FIG. 8 is provided and the “notification window” in the example of FIG. 7 is set as the notification method. In this case, the notification unit 228, by reference to the content of the record in the search result, performs processing for displaying the display window shown in FIG. 10 on the display screen of the client terminal, for example. FIG. 10 shows an example display window that displays a search result provided from the document management server 10 when the designated document is an ID-added document “Doc2” and a search condition including a condition of the derivation relationship that specifies “a document corresponding to a descendent of the designated document” and a condition that specifies “a document with regard to which the operation type is ‘viewing’ ” is set. When “mail” in the example shown in FIG. 7 is designated as the notification method, the notification unit 228 instructs an electronic mail transmitting/receiving application to send an electronic mail including text describing “viewed by user3 on Oct. 1, 2006, at 11:05,” “viewed by user4 on Oct. 1, 2006, at 11:45,” and “viewed by user6 on Oct. 1, 2006, at 13:35” as illustrated in FIG. 10, for example. Further, when the “icon” is designated in the example of FIG. 7, the notification unit 228 displays an icon representing the ID-added document “Doc2” displayed on the display screen of the client terminal 20 in a color different from that in normal time or displays an image of that icon with letters “viewing” superposing thereon.

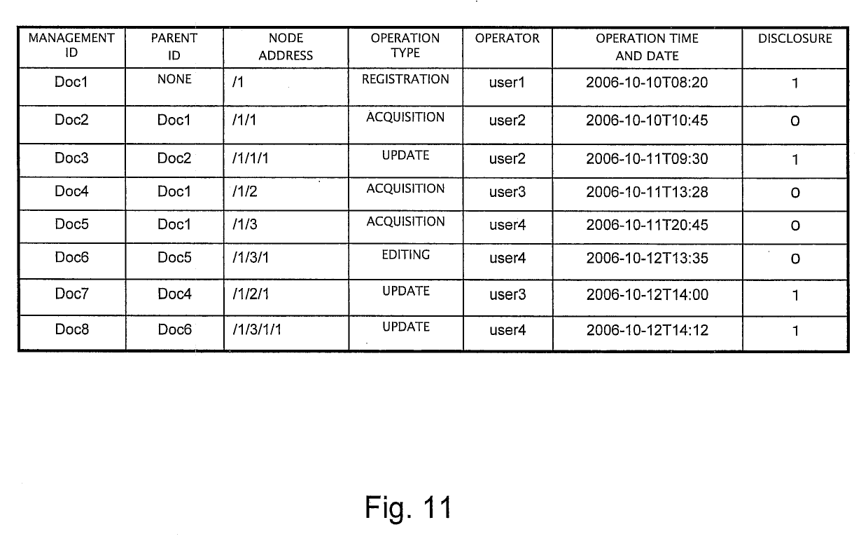

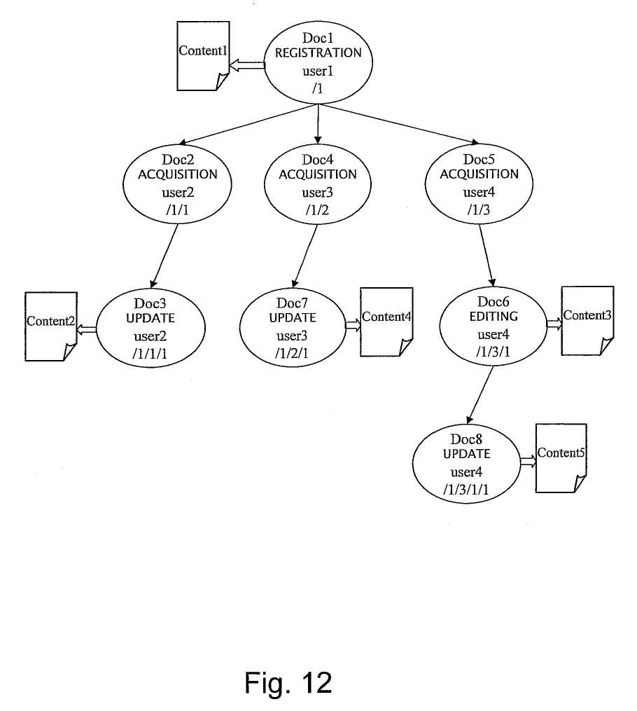

In the above-described example, there has been described processing that is performed when data including no “disclosure” attributes in the records, as in the data of contents illustrated in FIG. 5, are registered in the derivation relationship DB110. Alternatively, there are cases where data including “disclosure” attributes in the records are registered in the derivation relationship DB 110, as illustrated in FIG. 11. When the derivation relationship DB 110 registers the “disclosure” attributes as an item of the record, the request processing unit 140 performs processing using the “disclosure” attributes as in the example that will be described below. FIG. 11 shows an example history of documents in a case where a certain user has registered a questionnaire form that is a document for answering a questionnaire, and another user acquires the registered questionnaire form by downloading and fills in the form, and then registers the completed questionnaire form. FIG. 12 shows a tree structure formed by the data content shown in FIG. 11.

In this example, first, user1 performs a “registration” operation of a questionnaire form. In this example, a determination is made that a document that is registered in the present system through a “registration (initial registration)” operation and an “update (registration as an updated version)” operation is a subject of disclosure. With the “registration” operation by user1, an ID-added document having an management ID “Doc1” and a “disclosure” attribute value “1” indicative of a disclosure subject is generated, the document content of the document “Doc1” is registered in the document DB 100, and a record corresponding to the ID-added document “Doc1” is registered in the derivation relationship DB 110. Then, user2 performs an “acquisition” operation of the document having a management ID “Doc1” by using the document operation unit 200 of his/her own client terminal 20. Here, an “acquisition” operation refers to an operation for downloading or copying an ID-added document stored in the storage unit of the document management server 10 or the storage unit of the like of another client terminal 20. With the “acquisition” operation by user2, an ID-added document “Doc2” having a parent ID “Doc1” and a “disclosure” attribute value “0” indicative of a non-subject of disclosure is generated and registered in the document management server 10. Thereafter, when user2 fills in the questionnaire form; that is the ID-added document “Doc2,” and performs an operation of “registration as a updated version” with regard to the filled questionnaire form, a new ID-added document “Doc3” having a parent ID “Doc2” and a “disclosure” attribute value “1” is generated and registered in the document management server 10. Then, when user 3 “acquires” the ID-added document “Doc1,” an ID-added document “Doc4” having a “disclosure” attribute value “0” is generated and registered in the document management server 10, and when user 4 “acquires” the ID-added document “Doc1,” an ID-added document “Doc5” having a “disclosure” attribute value “0” is generated and registered in the document management server 10. Thereafter, when user4 performs an “editing” operation with respect to the ID-added document “Doc5,” an ID-added document “Doc6” having a “disclosure” attribute value “0” is generated and registered in the document management server 10. Then, user3 fills in the ID-added document “Doc4” and performs an operation of “registration as an updated version,” and registers in the document management server 10 an ID-added document “Doc7” having a “disclosure” attribute value “1” that is generated as a result of this operation. Further, when user4 then fills in the ID-added document “Doc6” and performs an operation of “registration as an updated version,” an ID-added document “Doc8” having a “disclosure” attribute value “1” that is generated as a result of this operation is registered in the document management server 10.

There are cases where, in a situation in which the operations shown in FIGS. 11 and 12 have been performed, user1 who registered the questionnaire form wishes to collect information concerning the documents of questionnaires completed by other users. In this case, user1, by setting, in the client terminal 20, the ID-added document “Doc1” as a designated document and setting a search condition including a condition of a derivation relationship that specifies “a document corresponding to a descendent of a designated document” and a condition that specifies “a document with regard to which the operation type is “update (registration as an updated version),” can receive from the document management server 10 information concerning a document acquired by completing the questionnaire form registered by user1.

Hereafter, there will be described processing performed by the request processing unit 140 when receiving, from the client terminal 20, a search instruction in which the ID-added document “Doc1” is set as a designated document and a search condition including a condition of a derivation relationship that specifies “a document corresponding to a descendent of the designated document” and a condition that specifies “a document with regard of which the operation type is “update (registration as an updated version)” is specified when the data of the contents illustrated in FIG. 11 are registered in the derivation relationship DB 110.

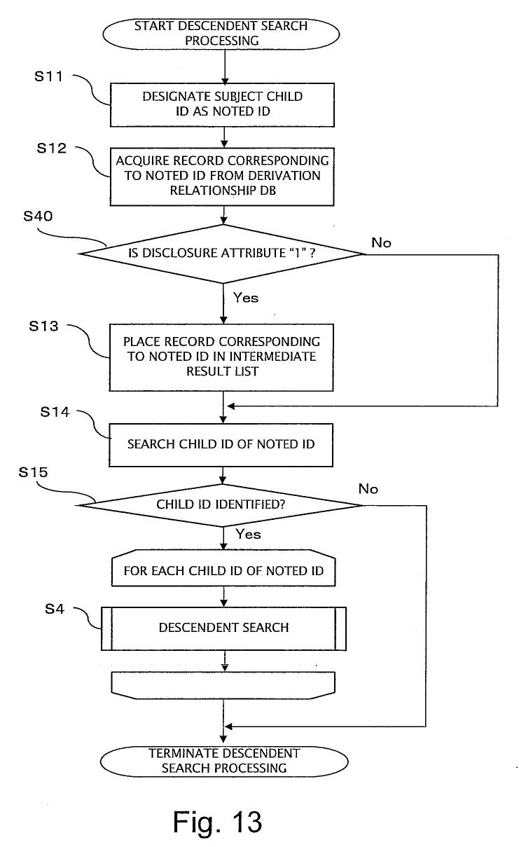

When data including the “disclosure” attribute as an item of a record as in the example shown in FIG. 11 are registered in the derivation relationship DB 110, the request processing unit 140 performs the processing described above with reference to FIG. 8. In this case, however, the request processing unit 140 performs processing in accordance with a procedure illustrated in FIG. 13 in place of the processing procedure illustrated in FIG. 9, in the descendent search processing in step S4. Specifically, as shown in FIG. 13, after setting the child ID as a noted ID (step S11) and acquiring a record corresponding the noted ID from the derivation relationship DB 110 (step S12), similar to steps S11 and S12 of the processing shown in FIG. 9, in step S40 a determination is made as to whether or not a “disclosure” attribute of the record that is acquired is “1.”. If the “disclosure” attribute of the acquired record is “1,” the process proceeds to step S13. On the other hand, if the “disclosure” attribute is “0,” the process proceeds to step S14 without performing the processing in step S13. In FIG. 13, the processing operations performed in step S13 and in subsequent steps are similar to those described above with reference to FIG. 9. By performing the determination processing in step S40, only records having the “disclosure” attribute “1” are recorded in the intermediate result list after completion of the descendent search processing shown in FIG. 13 (step S4 in FIG. 8). In the above-described example in which the document “Doc1” in FIG. 11 is set as a designated document, after completion of step S4, the intermediate result list stores records having the management IDs “Doc3,” “Doc7,” and “Doc8.” Then, in step S5 of FIG. 8, a record that satisfies the search condition is selected from the records having the “disclosure” attribute “1.” In the above-described example described with reference to FIG. 11, the condition that specifies “a document with regard to which the operation type is ‘update (registration as an updated version)’” is set, and all the records (having the management IDs “Doc3,” “Doc7,” and “DocB”) stored in the intermediate result list are of the operation type “update.” Accordingly, in this example, all the records (having the management IDs “Doc3,” “Doc7,” and “Doc8”) within the intermediate result list are selected in step S5. Then, in step S6, information concerning the documents corresponding to the records selected in step S5 is provided as a search result.

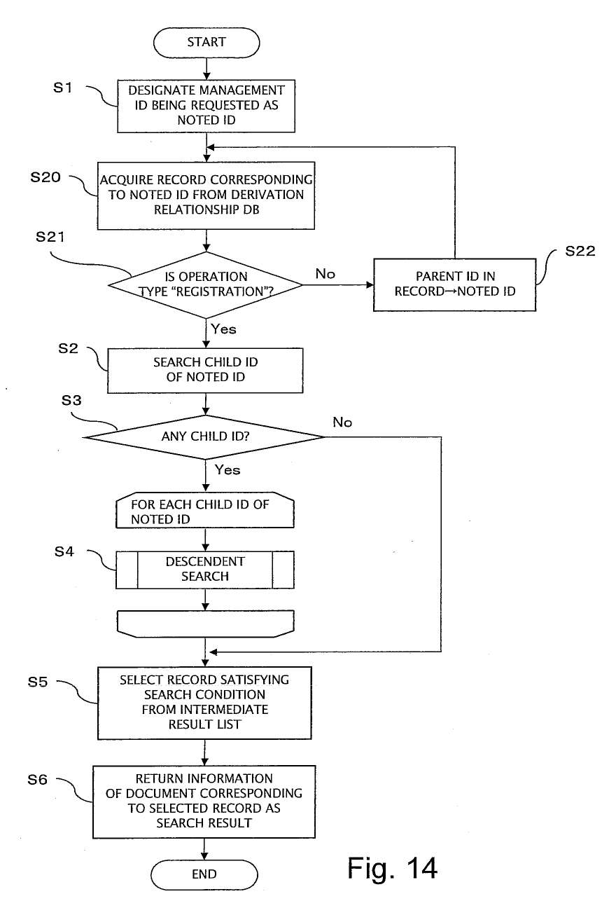

There has been described the processing performed by the request processing unit 140 when a condition that specifies “a document corresponding to a descendent of a designated document” is set as a condition of the derivation relationship. Next will be described processing performed by the request processing unit 140 when a condition that specifies “a document belonging to the same tree as that to which a designated document belongs” is set as a condition of the derivation relationship. When the condition that specifies “a document belonging to the same tree as that to which a designated document belongs” is set in the search request received from the client terminal 20, the request processing unit 140 performs processing having a procedure illustrated in FIG. 14.

In FIG. 14, processing operations similar to those in FIG. 8 are designated by the same reference numerals. In step S1, the request processing unit 140 extracts a management ID of a designated document from a service request (a search instruction) received from the client terminal 20 and sets the management ID as a noted ID. Then, in step S20, the request processing unit 140 acquires from the derivation relationship DB 110a record corresponding to the noted ID. Further, in step S21 a determination is made as to whether or not an item of an operation type in the acquired record is “registration.” If the operation type is “registration,” processing proceeds to step S2. If the operation type is not “registration,” processing proceeds to step S22.

In step S22, the request processing unit 140 sets the management ID registered in the item of the parent ID in the record acquired in step S21 as a noted ID, and then processing returns to step S20. This loop of steps S20 to S22 represents a processing for tracing back the tree structure of the derivation relationship starting from the management ID for which a service is being requested to thereby find a “registration” operation of a document that is an initiator (a root). If the determination result in step S21 is Yes, the noted ID at this time corresponds to the “registration” operation which is a root. In the example shown in FIG. 5, if the designated document has a management ID “Doc2,” the tree structure is traced back from the management ID “Doc2,” as a result of which the management ID “Doc1” that is a root is finally reached.

In FIG. 14, the processing operations in step S2 and subsequent steps are similar to those described above with reference to FIGS. 8 and 9. If the designated document has a management ID “Doc2” in the example of FIG. 5, upon completion of the processing in step S4, the records of documents belonging to the same tree as the tree to which the designated document “Doc2” belongs; i.e. all the records shown in FIG. 5, have been stored in the intermediate result list. Here, if a search condition including “a document with regard to which an operation type is “editing”” and “a document with regard to which the operation time is the latest” is set, for example, the record having an management ID “Doc4” in FIG. 5 is selected in step 5 of FIG. 14, and information concerning the ID-added document “Doc4” is provided in step S6. In this example, the latest version document related to the designated document is to be provided. Further, if the record registered in the derivation relationship DB 110 includes an item of the “disclosure” attribute, the descendent search processing in consideration of the “disclosure” attribute that has been described with reference to FIG. 13 is performed in step S4 of FIG. 14.

In another conceivable example, a boundary of search is set in the tree structure of the derivation relationships as a condition of the derivation relationship and search is performed within a range defined by the boundary.

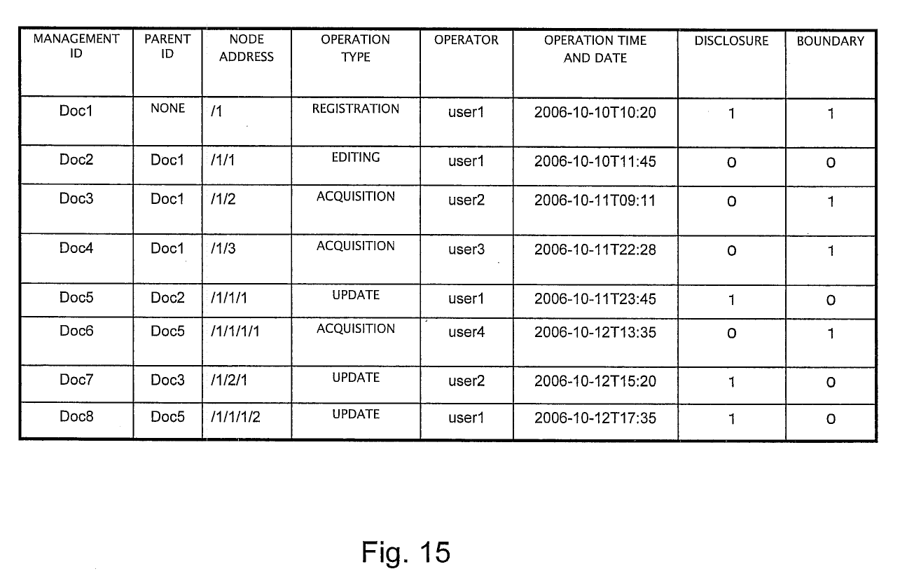

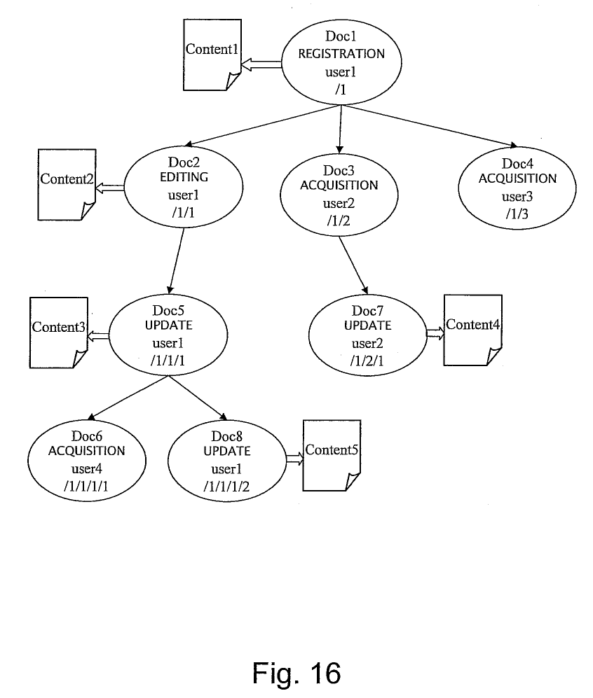

As an example for explaining such a case, a derivation relationship as shown in FIGS. 15 and 16 will be considered. This example shows a processing flow in which a certain user registers an application form (a model form) or the like in the present system and another user fills in the form and registers the completed form in the present system. The example data contents recorded in the derivation relationship DB 110 in this case are shown in FIG. 15. The contents of the derivation relationship DB 110 illustrated in FIG. 15 form a tree structure shown in FIG. 16.

In the example shown in FIG. 15, user1 creates a form such as an application form by using the document operating unit 200 of the client terminal 20, and registers the document as an ID-added document having a management ID “Doc1” in the document management server 10. Thereafter, user1 edits the ID-added document “Doc1” and registers the resultant ID-added document “Doc2.” Then, when user2 performs an “acquisition” operation with regard to the ID-added document “Doc1,” an ID-added document “Doc3” is registered. Further, user3 “acquires” the ID-added document “Doc1,” and an ID-added document “Doc4” is registered. Then, user1 “updates” the ID-added document “Doc2” that is an application form, and as a result an ID-added document “Doc5” is registered. Thereafter, when user4 “acquires” the ID-added document “Doc5,” an ID-added document “Doc6” is registered. Further, user2 fills in the application form (the ID-added document “Doc3”) which user2 has acquired, and performs a “registration” operation with regard to the filled application form as an updated version. As a result, an ID-added document “Doc7” is registered in the document management server 10. Further, user1 updates the application form with respect to the ID-added document “Doc5,” and performs an operation for “registration as an updated version,” and an ID-added document “DocB” is registered in the document management server 10. In the example shown in FIGS. 15 and 16, similar to the example shown in FIGS. 11 and 12, when a “registration” operation of a new document in the present system and an operation for “registering as an updated version” are performed, the value of the “disclosure” attribute is set to “1.”

In the example shown in FIGS. 15 and 16, the search boundary can be set in the tree structure of the derivation relationship. In order to represent the boundary, in the example shown in FIG. 15, a “boundary” attribute is included in the meta information of an ID-added document. If the value of the “boundary” attribute of a certain document is “1,” this indicates that a search boundary is set between that document and the parent thereof. On the other hand, if the value of the “boundary” attribute of a certain document is “0,” this indicates that that document and its parent belong to the same search range. The result of which operation type defines the search boundary has been previously registered in the document operating unit 200. In the example shown in FIG. 15, when a “registration” operation of a document and an “acquisition” operation of a document are performed in the document operating unit 200 of the client terminal 20, the “boundary” attribute is set to “1.” When the “boundary” attribute is set to “1,” this indicates that the ID-added document and a document corresponding to a parent ID thereof are documents in different ranges, although they are in a derivation relationship.

For example, the meta information record of the ID-added document “Doc3” shown in FIG. 15 is as described in the following Example 4.

### EXAMPLE 4

<metadata sid=“Doc3” pid=“Doc1” date=“2006-10-11T09:11” method=“download” user=“user2” shared=“0” unrelated=“1”/>

In this example, the attribute of “unrelated” corresponds to the “boundary” attribute. Further, in Example 4, “download,” which is a value of the “method” attribute, represents an “acquisition” operation.

In a conceivable situation, a certain user generates and registers a document of a specific form (hereinafter referred to as an “original document”) in the document management server 10, and another user acquires, through a downloading operation, the original document registered in the document management server 10, fills in the original document, and then registers the completed document in the document management server 10, as in the example shown in FIGS. 15 and 16. In such a situation, if the user who generated and registered the original document appropriately edits the original document and registers the edited document as an updated version, another user who intends to fill in the original document may wish to confirm whether or not the updated version of the original document exists and acquire the original document in its updated version. In such a case, according to the present embodiment, if a user selects the “original document” as a condition of derivation relationship on the display screen for setting the notification condition as shown in FIG. 7, for example, information concerning the update of the original document is to be provided.

Hereinafter, there will be described example processing in which user3 sets the application form (“Doc4”) with respect to which user3 himself performed an “acquisition” operation as a designated document and selects the “original document” as a condition of derivation relationship in the display screen illustrated in FIG. 7. If the user selects the “original document,” the set condition of the derivation relationship is a condition that specifies “a document included in a range defined by the search boundary in a partial tree formed of descendents of a document of an ‘acquisition’ target (i.e. a parent document of a document corresponding to the ‘acquisition’ operation)”, and a condition that specifies “a document with regard to which the operation type is ‘update’ ” is set as a search condition. Assuming that the document “Doc4” is set as a designated document in the example shown in FIGS. 15 and 16, in a partial tree formed of descendents of a document (“Doc1”) which is a target of “acquisition,” documents included in a range defined by the search boundary (documents “Doc2,” “Doc5,” and “Doc8”) are to be subjects of search.

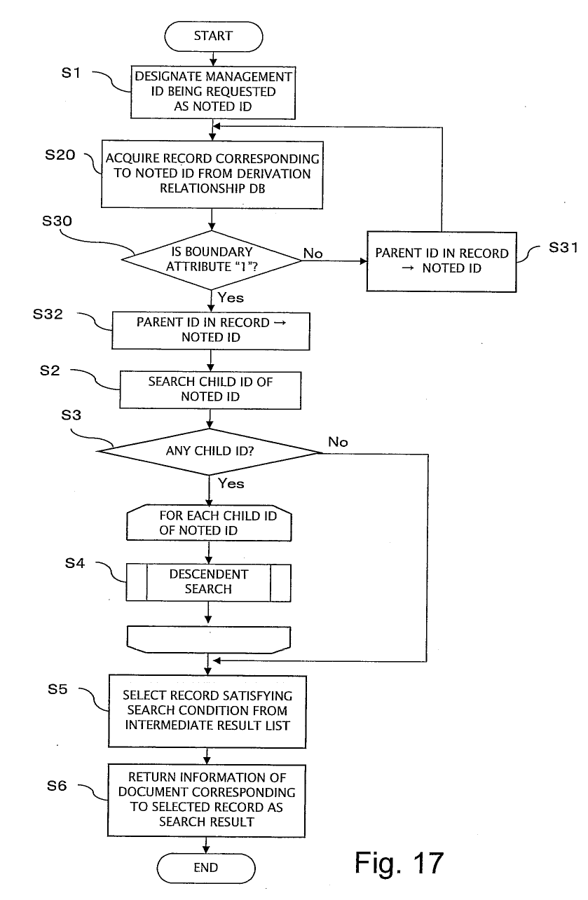

FIG. 17 shows example processing performed by the request processing unit 140 when the “original document” is selected as a condition of the derivation relationship. First, in step S1, the request processing unit 140 sets as a noted ID a management ID for which a service is being requested. Then, in step S20, the request processing unit 140 acquires a record corresponding to the noted ID from the derivation relationship DB 110. In step S30, the request processing unit 140 determines whether or not a value of the “boundary” attribute in the record acquired in step S20 is “1.” If the value of the “boundary” attribute is “0,” the request processing unit 140 sets the parent ID in the record as a noted ID in step S31 and processing returns to the processing in step S20. On the other hand, if the value of the “boundary” attribute is “1,” the request processing unit 140 sets the parent ID in the record as a noted ID in step S32 and processing proceeds to step S2. With the processing loop formed of steps S20, S30, and S31, the tree structure of the derivation relationship is traced back from a document corresponding to the management ID of the designated document to a record having a value of the “boundary” attribute “1.” The processing operations in step S2 and the subsequent steps are similar to those described above with reference to FIGS. 8 and 14.

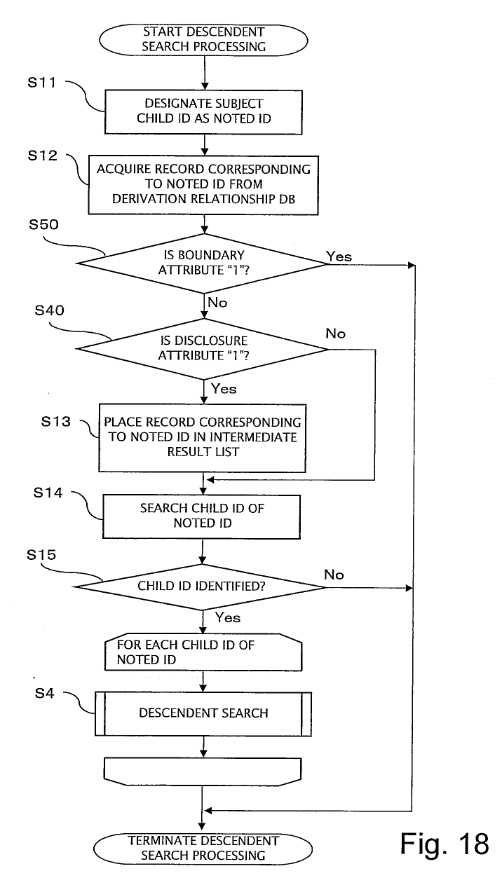

FIG. 18 shows an example processing procedure performed in the descendent search processing in step S4 of FIG. 17 when the “boundary” attribute is set. When the descendent search processing in step S4 of FIG. 17 is started, the subject child ID is set as a noted ID in step S1, and a record corresponding to the noted ID is acquired from the derivation relationship DB 110 in step S12. Then, in step S50, a determination is made as to whether or not the “boundary” attribute of the acquired record is “1.” If the “boundary” attribute is “1,” the descendent search processing is terminated without performing any processing during and after step S40. On the other hand, if the “boundary” attribute is “0,” processing proceeds to step S40. In step S40, a determination is made as to whether or not the “disclosure” attribute of the record acquired in step S12 is “1.” If the “disclosure” attribute is “1,” processing proceeds to step S13. On the other hand, if the “disclosure” attribute is “0,” processing proceeds to step S14 without performing the processing in step S13. The processing operations in step S13 and the subsequent steps are similar to those in step S13 and the subsequent steps described above with reference to FIGS. 9 and 13. In the descendent search processing illustrated in FIG. 18, search of a descendent concerning a record having the “boundary” attribute “1” is not performed. It should be noted that, in a case wherein the descendent search processing shown in FIG. 18 is performed when the records in the derivation relationship DB 110 include no items of the “disclosure” attribute, if the “boundary” attribute is “0” in step S50, processing proceeds to step S13 without performing determination of a value of the “disclosure” attribute in step S40.

Referring again to FIG. 17, upon completion of the descendent search processing in step S4 (FIG. 18), the intermediate result list is supposed to store records having the “disclosure” attribute “1” among the records corresponding to documents belonging to a partial tree that includes a parent document of a first document that sets the search boundary while tracing back the tree structure of the derivation relationship from the designated document and that is defined by the search boundary. In step S5, a record that satisfies a search condition is selected from the records in this intermediate result list. In this case, because a condition specifying “a document with regard to which the operation type is ‘update’ ” is set as a search condition, when the document “Doc4” in FIGS. 15 and 16 is set as a designated document, records corresponding to the documents “Doc5” and “Doc8” are selected. If a condition that specifies “a document with regard to which the operation time is the latest” has been additionally set by a user as a search condition, a record including the operation type “update” as well as the latest operation time is selected in step S5. Then, in step S6, the request processing unit 140 sends to the client terminal 20 information concerning the documents corresponding to the records selected in step S5.

In a case wherein the search boundary is set by the “acquisition” operation as in the example shown in FIGS. 15 and 16, if the user selects the “original document” as a condition of the derivation relationship, the processing described above with reference to FIGS. 17 and 18 is performed. Specifically, a search processing is performed with documents included in a partial tree that includes a parent document of a document that sets a search boundary and that is defined by the search boundary being set as search subjects. When user3 sets a document having the management ID “Doc4” as a designated document, for example, among the documents derived from the parent document (“Doc1”), documents for which an “update” operation has been performed are documents “Doc5,” “Doc7,” and “Doc8.” However, with regard to the document “Doc3” that is a parent document of the document “Doc7,” the “boundary” attribute is set to “1” and therefore the document “Doc7” is not included in the intermediate result list. When the search boundary is defined by the “acquisition” operation as described above, an “update” operation in which the application form itself is modified and an “update” operation in which a user fills in the application form can be distinguished from each other. The “boundary” attribute may be set to “1” with regard to the operations other than the “acquisition” operation as required.

Although in the exemplary embodiment and the modified examples described above the management ID is issued by each client terminal 20, the document management server 10 may instead issue the management ID. In this case, the client terminal 20, when performing an operation with respect to an ID-added document, generates document data which include the management ID in the ID-added document prior to the operation as the parent ID 314, the log information 316 concerning the operation, and the document content 320 acquired as a result of the operation, with no management ID 312, and sends the document data to the document management server 10. The document management server 10 then assigns a new management ID to the document data that is received and registers the management ID and the information included in the document data in the document DB 100 and the derivation relationship DB 110. The document management server 10 further sets the assigned management ID in the document data to generate an ID-added document, and returns this ID-added document to the client terminal 20. The client terminal 20 then replaces the ID-added document prior to the operation with the ID-added document that is received. As such, the processing of the exemplary embodiment and the modified examples described above can be similarly executed in a structure in which the management ID is assigned by the document management server 10.

Further, although in the exemplary embodiment and modified examples described above the ID-added document 300 including the management ID 312, the parent ID 314, the log information 316, and the document content 320 is stored in the client terminal 20, it may be the case that only the management ID 312 is stored in the client terminal 20 and other information is stored in the document management server 10. In this case, the client terminal 20, when performing an operation with regard to a document, sends the management ID corresponding to the document to the document management server 10, which then provides the corresponding document to the client terminal 20. Further, as another example, an ID-added document 300 stored in the client terminal 20 may include the management ID 312 and the document content 320 and does not include the parent ID 314 and the log information 316. In this case, the document management server 10 may store the parent ID 314 and the log information 316 in association with the management ID 312.

Here, when the document management server 10 assigns a management ID, the document management server 10 generates a management ID corresponding to the acquisition operation and provides the client terminal 20 with the management ID in association with the document. The document management server 10 also records, in the derivation relationship DB 110, the log information (the operation time and date, the operator, and so on) concerning the acquisition operation, the earlier management ID (i.e. the parent ID), and the assigned management ID. The client terminal 20 replaces the management ID sent to the document management server 10 with the management ID that is received, and opens the received document. The user then performs an operation such as viewing and editing with respect to the opened document. Upon completion of the operation with respect to the document, the client terminal 20 sends the document acquired by the operation, along with the management ID and the log information concerning the operation, to the document management server 10. The document management server 10 assigns a new management ID to the document that is received and registers the document with the new management ID in the derivation relationship DB 110, and further registers the management ID that is received from the client terminal 20 in the derivation relationship DB 110 as the parent ID. In addition, the document management server 10 registers the log information and the document after the operation that is received in the derivation relationship DB 110 and the document DB 100, respectively. The document management server 10 then returns the management ID newly assigned to the client terminal 20. The client terminal 20 replaces the earlier management ID with the received management ID. With the above processing, the derivation relationships among the operations are to be accumulated in the document management server 10.

On the other hand, in the structure in which the management ID is assigned by the client terminal 20, the document management server 10 can simply return to the client a document corresponding to the management ID received from the client terminal 20. The client terminal 20 opens the document that is received, so that the user can perform operations on the document. After completion of the operation, the client terminal 20 assigns a new management ID to the document acquired as a result of the operation and sends to the document management server 10 the ID-added document described above including this new management ID and the corresponding information. Then, the client terminal 20 stores only the management ID in the ID-added document and deletes other information.

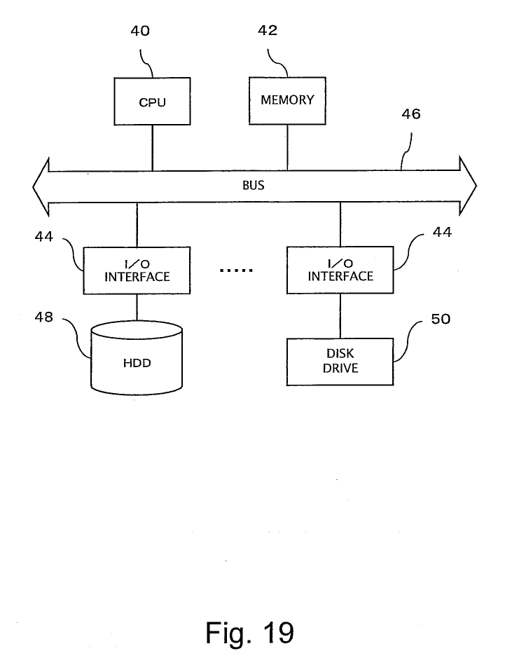

The document management server 10 in the illustrated system described above is typically implemented by a general-purpose computer executing a program that describes the function or processing contents of each unit of the document management server described above. As shown in FIG. 19, the computer includes, as hardware, a circuit structure in which a CPU (central processing unit) 40, a memory (primary memory) 42, various I/O (input/output) interfaces 44, and other elements are interconnected via a bus 46, for example. Further, a hard disk drive 48 and a disk drive 50 for reading a portable non-volatile recording medium of various standards such as CDs and DVDs and flash memories are connected, via the I/O interfaces 44, for example, to the bus 46. Such a drive 48 or 50 functions as an external storage device for the memory. The program that describes the processing contents of the exemplary embodiment is stored in a fixed storage device such as the hard disk drive 48 via a recording medium such as a CD or DVD or via the network, and then installed in the computer. When the program stored in the fixed storage device is read into the memory and performed by the CPU, the processing of the exemplary embodiment is implemented. Similarly, the client terminal 20 can be implemented by causing a general-purpose computer to perform a program that describes the document processing program described above.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The exemplary embodiments were chosen and described in order to best explain the principles of the invention and its practical application, thereby enabling others skilled in the art to understand the invention for various embodiments and with various modifications as are suited to the particular use contemplated. It is intended that the scope of the invention be defined by the following claims and their equivalents.

What is claimed is:

1. A first information processing apparatus, comprising:
a registration unit that receives, from an information processing apparatus, information of a derivation relationship in which a first document is a parent and a second document generated as a result of an operation performed with respect to the first document is a child and registers the information in a storage unit; and
a search result output unit that, in accordance with a search instruction that specifies a designated document and a search condition including a condition that defines a derivation relationship that should exist between the designated document and a search subject document, outputs, as a search result, information concerning a document that satisfies the search condition among documents included in derivation relationships registered in the storage unit.

2. The first information processing apparatus according to claim 1, wherein
the registration unit further receives from the information processing apparatus operation-related information that is information concerning an operation performed with respect to the first document and registers the operation-related information in the storage unit, and
the search condition further includes a condition concerning the operation-related information.

3. The first information processing apparatus according to claim 1, wherein
the registration unit further receives from the information processing apparatus disclosure attribute information that indicates whether or not the second document is a subject of disclosure and registers the disclosure attribute information in the storage unit in association with the second document, and
the search result output unit outputs, as a search result, information concerning a document that satisfies the search condition and that is associated with the disclosure attribute information indicative of a subject of disclosure among documents included in derivation relationships registered in the storage unit.

4. The first information processing apparatus according to claim 2, wherein
the registration unit further receives from the information processing apparatus disclosure attribute information that indicates whether or not the second document is a subject of disclosure and registers the disclosure attribute information in the storage unit in association with the second document, and
the search result output unit outputs, as a search result, information concerning a document that satisfies the search condition and that is associated with the disclosure attribute information indicative of a subject of disclosure among documents included in derivation relationships registered in the storage unit.

5. A computer readable medium storing a program causing a computer to execute a process for managing electronic documents, the process comprising:
receiving, from an information processing apparatus, information of a derivation relationship in which a first document is a parent and a second document generated as a result of an operation performed with respect to the first document is a child and registering the information in a storage unit; and
in accordance with a search instruction that specifies a designated document and a search condition including a condition that defines a derivation relationship that should exist between the designated document and a search subject document, outputting, as a search result, information concerning a document that satisfies the search condition among documents included in derivation relationships registered in the storage unit.

6. A second information processing apparatus, comprising:
a transmission unit that transmits, to a first information processing apparatus that stores information concerning a derivation relationship among documents, information of a derivation relationship in which a first document is a parent and a second document generated as a result of an operation performed with respect to the first document is a child;
a notification condition acquisition unit that acquires a notification condition including a condition that determines a designated document and a search condition including a condition that specifies a derivation relationship that should exist between the designated document and a search subject document; and
a search instructing unit that issues to the first information processing apparatus a search instruction that specifies the designated document and the search condition, in accordance with the notification condition acquired by the notification condition acquisition unit.

7. The second information processing apparatus according to claim 6, wherein
the transmission unit further transmits to the first information processing apparatus operation-related information that is information concerning an operation performed with respect to the first document, and
the notification condition further includes a condition concerning the operation-related information.

8. The second information processing apparatus according to claim 6, wherein
the notification condition acquisition unit acquires a notification condition further including a condition that specifies a time for notification of information concerning a document related to the designated document, and
the search instructing unit issues the search instruction to the first information processing apparatus at the time specified in the notification condition.

9. The second information processing apparatus according to claim 7, wherein
the notification condition acquisition unit acquires a notification condition further including a condition that specifies a time for notification of information concerning a document related to the designated document, and
the search instructing unit issues the search instruction to the first information processing apparatus at the time specified in the notification condition.

10. The second information processing apparatus according to claim 6, further comprising:
a notification unit that notifies a user of a search result provided from the first information processing apparatus,
wherein
the notification condition acquisition unit acquires a notification condition further including a condition that specifies a method for notification of the search result, and
the notification unit notifies the user of the search result in a manner specified in the notification condition.

11. The second information processing apparatus according to claim 7, further comprising:
a notification unit that notifies a user of a search result provided from the first information processing apparatus,
wherein
the notification condition acquisition unit acquires a notification condition further including a condition that specifies a method for notification of the search result, and
the notification unit notifies the user of the search result in a manner specified in the notification condition.

12. The second information processing apparatus according to claim 8, further comprising:
a notification unit that notifies a user of a search result provided from the first information processing apparatus,
wherein
the notification condition acquisition unit acquires a notification condition further including a condition that specifies a method for notification of the search result, and
the notification unit notifies the user of the search result in a manner specified in the notification condition.

13. The second information processing apparatus according to claim 9, further comprising:
a notification unit that notifies a user of a search result provided from the first information processing apparatus,
wherein
the notification condition acquisition unit acquires a notification condition further including a condition that specifies a method for notification of the search result, and
the notification unit notifies the user of the search result in a manner specified in the notification condition.

14. A computer readable medium storing a program causing a computer to execute a process for managing electronic documents, the process comprising:
transmitting, to a first information processing apparatus that stores information concerning a derivation relationship among documents, information of a derivation relationship in which a first document is a parent and a second document generated as a result of an operation performed with respect to the first document is a child;
acquiring notification condition including a condition that determines a designated document and a search condition including a condition that defines a derivation relationship that should exist between the designated document and a search subject document; and
issuing to the first information processing apparatus a search instruction that specifies the designated document and the search condition, in accordance with the notification condition acquired by the acquiring.

15. An information processing system comprising a first information processing apparatus and a second information processing apparatus,
the second information apparatus including:
a transmission unit that transmits, to the first information processing apparatus, information of a derivation relationship in which a first document is a parent and a second document generated as a result of an operation performed with respect to the first document is a child;
a notification condition acquisition unit that acquires notification condition including a condition that determines a designated document and a search condition including a condition that specifies a derivation relationship that should exist between the designated document and a search subject document; and
a search instructing unit that issues to the first information processing apparatus a search instruction that specifies the designated document and the search condition, in accordance with the notification condition acquired by the notification condition acquisition unit, and
the first information processing apparatus including:
a registration unit that receives, from the second information processing apparatus, information of the derivation relationship and registers the information in a storage unit; and
a search result output unit that, in accordance with the search instruction, outputs, as a search result, information concerning a document that satisfies the search condition among documents included in derivation relationships registered in the storage unit.
